(19) United States
(12) Patent Application Publication
(10) Pub. No.: US 2004/0140940 A1
(43) Pub. Date: Jul. 22, 2004

(54) Allround aerial arrangement for receiving terrestrial and satellite signals

(76) Inventors: Marco Vothknecht, Rosenheim (DE); Pete Prassmayer, Grosskarolinenfeld (DE)

Correspondence Address: NIXON & VANDERHYE, PC, 1100 N GLEBE ROAD, 8TH FLOOR, ARLINGTON, VA, 22201-4714, US

(21) Appl. No.: 10/476,692

(22) PCT Filed: Feb. 27, 2003
(86) PCT No.: PCT/EP03/02027

(30) Foreign Application Priority Data
Mar. 7, 2002 (DE) 102 09 996.0

(51) Int. Cl. H01Q 21/00; H01Q 1/00

(52) U.S. Cl. 343/725; 343/700 MS; 343/729

(57) ABSTRACT

An improved combination antenna for receiving terrestrial, in particular vertically polarized signals, and for receiving in particular circular polarized satellite signals in accordance with the SDARS services, preferably in a 2.3 GHz band, having the following features:

a monopole arrangement (7) is provided for receiving terrestrial signals,

a satellite receiving antenna is provided for receiving circular polarized satellite signals,

only a single monopole (7) is provided, and

the satellite receiving antenna is in the form of a patch antenna (9).

The invention relates to a combination antenna for receiving terrestrial and satellite signals, as claimed in the precharacterizing clause of claim 1.

A satellite-based radio system which operates with only a small number of satellites in distributed orbits is used, in particular in the USA. The aim is to offer antennas for this satellite-based radio system which have to provide the same minimum gain even at low elevation angles from 25° up to an elevation of 90°.

At the same time, the combination antennas are also intended to be suitable for receiving terrestrial signals.

The corresponding systems are also known in the specialist field by the expression SDARS services, which transmit in the 2.3 GHz band. The satellite signals are in this case transmitted with circular polarization.

In order to take account of these extreme conditions and to provide a high antenna gain even at low elevations of 25° or more, continuous attempts have been made to take account of these extreme requirements by specially adapted antenna structures.

A special antenna system has thus become known on the USA market, which contains a cruciform dipole that is formed from a flat material and thus forms four quadrants which are separated from one another by the dipole walls. A separate, vertically extending monopole is then arranged in each quadrant, via which the terrestrially transmitted vertically polarized signals can be received. However, the overall complexity of the antenna is considerable since, in particular, appropriate feed networks are also required in order to feed the cruciform dipole and the four monopoles.

The publication “A Combination Monopole/Quadrifilar Helix Antenna For S-Band Terrestrial/Satellite Applications” in the Microwave Journal May 2001 likewise describes a combination antenna which is intended to be suitable for satellite reception on the basis of the SDARS services in the USA. This antenna is likewise intended to have a good antenna gain and a sufficiently good axis ratio even at elevation angles of around 25°. These antennas have a rod monopole which extends vertically, and around which a helix is arranged.

Finally, however, EP 1 100 148 A1 also discloses a correspondingly circular polarized cross dipole antenna, which has two pairs of inverted V-shaped dipole antenna arrangements. These antenna dipole elements are curved like an inverted “V”.

In contrast, the object of the present invention is to provide an improved antenna system in particular for the SDARS services in the USA, which makes it possible to receive not only terrestrial, particularly vertically polarized, signals, but also to receive in particular circular polarized satellite signals, with the satellites not only being positioned in the elevation angle range around 90° but also, in some cases, also being positioned low above the horizon, at an elevation of around 25°.

According to the invention, the object is achieved on the basis of the features specified in claim 1.

Advantageous refinements of the invention are specified in the dependent claims.

If the normal specifications of the system operators are taken into account for such difficult reception conditions, then it is immediately evident from them that, in the opinion of the overall specialist world, only specially developed combination antennas can take account of the desired requirements.

It is therefore even more surprising that it has not only been possible to comply with the required boundary conditions, but to exceed them, with the solution according to the invention.

The combination antenna according to the invention on the one hand has a monopole for receiving terrestrial, in particular vertically polarized, signals. This monopole may be designed in various ways. However, in particular, the antenna according to the invention is in the form of a patch antenna, which is known per se.

However, it has long been known in the specialist world that patch antennas achieve their optimum function at the zenith, that is to say at an elevation of 90°. The antenna gain reaches its maximum at this point, with the axis ratio of circular polarized patch antennas conversely reaching a minimum.

However, the antenna gain and axis ratio parameters become continuously worse in the direction of lower elevation angles.

It was therefore always expected that patch antennas would be completely unsuitable in particular for receiving satellite signals on the basis of the SDARS service in the USA. No corresponding proposals using patch antennas have therefore become known.

It must therefore be regarded as being extremely surprising that the combination antenna according to the invention, including a patch antenna element, makes it possible to achieve optimum values with regard to the antenna gain on the one hand and the axis ratio on the other hand even at low elevation angles of 25°, with these parameter values being comparable to the values for the antenna gain and axis ratio as can be expected at an elevation of 90°!

In one particularly preferred embodiment of the invention, a monopole which extends in the form of a vertical rod is in this case used in addition to the patch antenna as an antenna element for receiving terrestrial signals, as is known per se from the prior art.

In order to allow construction with a low height, an inverted F antenna, for example composed of wire or the like, is also preferably used, and can be arranged on a substrate, for example on a printed circuit board.

However, a printed circuit for example on a printed circuit board can just as well be used as a monopole, and can be arranged vertically on a substrate in the form of a further printed circuit board. A stripline conductor for the monopole can be formed on this additional vertically extending printed circuit board, which is provided for the monopole, and can also run in an S-shape or meandering shape in the form of a square-wave pulse in order to reduce the physical height.

However, in one particularly preferred embodiment, an antenna element having a cavity is used in whose top face, for example in the form of a metal plate, an annular slot is provided. The annular slot in this case acts as a monopole.

In order to reduce the overall physical height, the cavity, that is to say the cavity that is located underneath the slot, is preferably filled with a dielectric, for example with glass, ceramic or the like. Since the dielectric constant ε_{R} of glass has, for example, a value of around 9 and that of ceramic has a value of around 20 to 30, this leads to the cavity size being reduced to one third when using glass or to one fifth when using ceramic. It is thus possible to produce combination antennas with a very small physical height for receiving SDARS services.

Further advantages, details and features of the invention will become evident in the following text from the exemplary embodiments which are illustrated in the drawings, in which, in detail:

FIG. 1 shows a schematic side view of an antenna according to the invention;

FIG. 2 shows a plan view of the exemplary embodiment as shown in FIG. 1 of the antenna according to the invention;

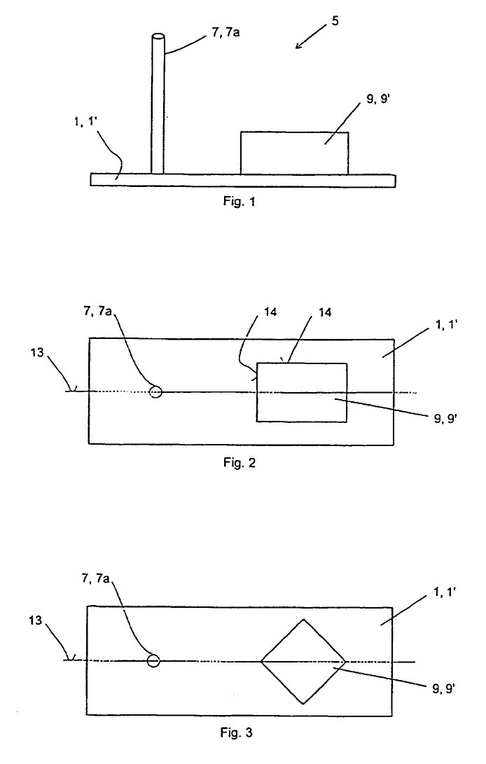

FIG. 3 shows a plan view, comparable to that in FIG. 2, relating to a slightly modified exemplary embodiment;

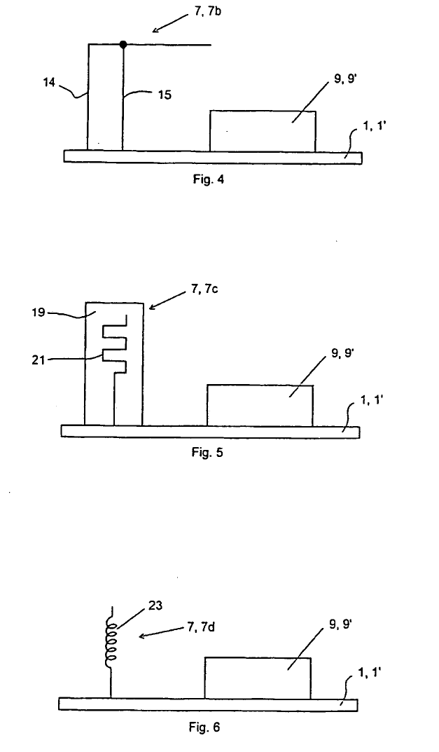

FIG. 4 shows a further modified exemplary embodiment relating to an inverted F antenna as a monopole;

FIG. 5 shows a stripline conductor monopole antenna for a further modified exemplary embodiment;

FIG. 6 shows another modified exemplary embodiment relating to a monopole;

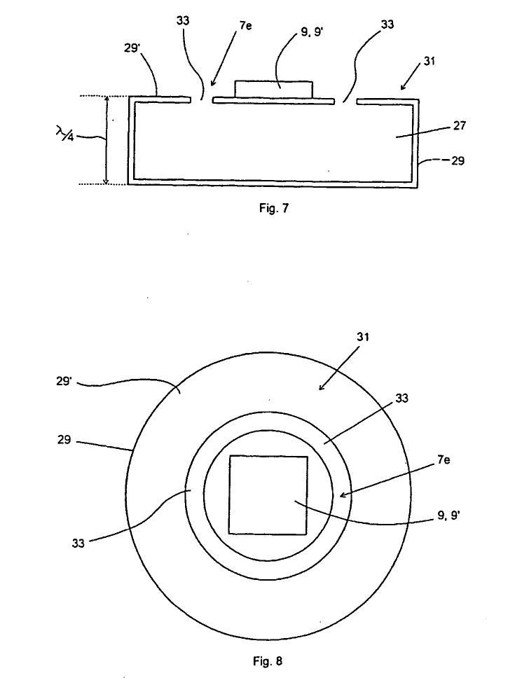

FIG. 7 shows a plan view of a further modified exemplary embodiment of a combination antenna with an annular slot instead of a monopole antenna element; and

FIG. 8 shows a cross-sectional illustration relating to the exemplary embodiment shown in FIG. 7.

FIG. 1 shows a combination antenna 5 for reception of SDARS services (which are normally transmitted in the 2.3 GHz band) in the USA, preferably in the form of a printed circuit board 1′ on a substrate 1.

A monopole 7 is provided vertically on the substrate 1, that is to say a rod monopole 7a in the illustrated exemplary embodiment. A patch antenna 9 is formed on the substrate 1 on the side, alongside the monopole 7a. Both antenna elements 7 and 9 are fed in a known manner.

The patch antenna 9 is preferably in the form of a ceramic patch antenna 9′. Since the mechanical size of the patch antenna 9 depends on the resonant frequency on the one hand and on the dielectric constant of the material to be used on the other hand, with a microwave ceramic normally being used [lacuna] . Since the patch antenna is intended to be used to receive circular polarized electromagnetic waves in the 2.3 GHz band, and the physical mechanical size of the patch antenna in this case depends, as mentioned, on the resonant frequency, this results in a comparatively physically small patch antenna 9 and, surprisingly in this case, the capability of patch antenna 9 such as this to comply with the stringent requirements in accordance with the normal system specifications of the system operators, on the basis of which the antenna gain should be greater than 3 dBic in the elevation range between 25° and 90°.

FIG. 2 shows the plan view of the antenna arrangement shown in FIG. 1. This shows that the monopole is arranged on a vertical central longitudinal plane 13, which runs parallel or at right angles to the side boundaries 14 of the patch antenna 9, which is square in a plan view.

The exemplary embodiment in FIG. 3 shows only schematically that the patch antenna can also be arranged rotated through 45° with respect to the exemplary embodiment shown in FIGS. 1 and 2, so that the vertically extending monopole 7 (which, by way of example, is in the form of a rod in the illustrated exemplary embodiment) lies on a vertical central plane of symmetry 13 which runs diagonally through the patch antenna 9.

FIG. 4 shows only a schematic side view, illustrating that an inverted F antenna 7b can also be used instead of a rod monopole 7, one limb 14 of which inverted F antenna 7b is, connected to ground on the substrate 1, 1′ while, in contrast, the monopole is fed with a high impedance via an offset feed line 15.

However, as is shown in FIG. 5, a monopole 7c in the form of a stripline conductor can also be used instead of the monopole 7a or 7b, and is fitted to a substrate, for example to a further separate printed circuit board 19. In order to reduce the physical height, the stripline conductor 21 may in this case be arranged in a meandering shape or running in the form of a square-wave pulse on the substrate or on the printed circuit board 19.

The exemplary embodiment shown in FIG. 6 uses a monopole 7d, in which the rod monopole is in the form of a coiled former 23 at the end remote from the printed circuit board 1′.

In one particularly preferred embodiment shown in FIGS. 7 and 8, a combination antenna is used which has a cavity 27 that is formed by a housing 29 which bounds the cavity 27. The housing 29 can preferably be provided with a metallic surface.

An annular slot 33 is incorporated in the appropriate housing wall 29′ on the top face 31.

In the interior of the annular slot 33, the patch antenna 9 is in a position on the top face 31, that is to say on the upper housing wall 29′, and is in this case fed in a known manner. The annular slot 33 runs around the patch antenna 9 in the upper housing wall 29′, and its polar diagram is comparable to that of a monopole.

As indicated in FIG. 8, the physical height corresponds to λ/4 of the operating mid-frequency. Thus, if the antenna is operated in the 2.3 GHz band, this results in a physical height of approximately 5 cm.

However, this physical height can effectively be reduced by filling the cavity 27 with a dielectric. Glass or ceramic may be used, for example, as a suitable dielectric, thus allowing the mechanical dimensions to be reduced considerably.

Since glass, for example, has a dielectric constant of around 9, this leads to the physical height being reduced by a factor of 3. If ceramic is used as the dielectric having, for example, a dielectric constant of 20 to 30, this leads to the physical height being reduced by a factor of 5.

It is thus evident from the described design that the present invention is also suitable in a highly surprising manner for reception of programs which are transmitted by satellites located at a comparatively low angle above the horizon. In this case, it is highly surprising that a patch antenna can achieve such a high antenna gain when the satellite signals are transmitted at an angle of less than 50°, in particular even less than 40° or even less than 30°, namely in particular even around 25°. This is surprising, because, as is known, patch antennas achieve their maximum antenna gain only when the signals are transmitted from the zenith, or are received in the zenith direction, that is to say aligned at right angles to the plane of the horizontal. All antenna systems which have become known in the past and were intended to be suitable for a comparable problem, in particular for receiving SDARS services, therefore invariably proposed solutions which were deliberately not based on patch antennas.

1. A combination antenna for receiving terrestrial, in particular vertically polarized, signals and for receiving in particular circular polarized satellite signals in accordance with the SDARS services, preferably in a 2.3 GHz band, having the following features:
a monopole arrangement (7) is provided for receiving terrestrial signals,
a satellite receiving antenna is provided for receiving circular polarized satellite signals,
characterized by the following further features:
only a single monopole (7) is provided, and
the satellite receiving antenna is in the form of a patch antenna (9).

2. The combination antenna as claimed in claim 1, characterized in that both the monopole (7) and the patch antenna (9) are formed and connected on a substrate (1), preferably in the form of a printed circuit board (1′).

3. The combination antenna as claimed in claim 1 or 2, characterized in that the monopole (7) is in the form of a rod monopole (7a).

4. The combination antenna as claimed in claim 1 or 2, characterized in that the monopole (7) is formed from an inverted F antenna (7b).

5. The combination antenna as claimed in claim 1 or 2, characterized in that the monopole (7, 7c) is formed from a stripline conductor (21) or from a printed structure, which is preferably formed on a further substrate (19), in particular in the form of a printed circuit board.

6. The combination antenna as claimed in claim 5, characterized in that the stripline conductor (21) is provided such that it runs in a meandering shape on the substrate (19).

7. The combination antenna as claimed in claim 1 or 2, characterized in that the rod monopole (7, 7d) is provided with a coil former (23) at the end opposite the substrate (1).

8. The combination antenna as claimed in claim 1 or 2, characterized in that an annular slot (33) is formed in one housing wall (29′) of a housing (29) which surrounds a cavity (27).

9. The combination antenna as claimed in claim 8, characterized in that the patch antenna (9) is arranged within the annular slot (33).

10. The combination antenna as claimed in claim 8 or 9, characterized in that the cavity (27) is filled with a dielectric.

11. The combination antenna as claimed in claim 10, characterized in that the dielectric is glass or ceramic.

12. The combination antenna as claimed in one of claims 1 to 11, characterized in that the monopole (7) is arranged on a vertical central longitudinal plane (13) which passes through the patch antenna (9), with the vertical central longitudinal plane (13) being aligned at right angles or parallel to the side boundary edges (14) of the patch antenna (9).

13. The combination antenna as claimed in one of claims 1 to 11, characterized in that the monopole (7) is arranged on a vertical central longitudinal plane (13) which passes through the diagonal of the patch antenna (9).
